(19) United States
(12) Patent Application Publication
(10) Pub. No.: US 2024/0260003 A1
(43) Pub. Date: Aug. 1, 2024

(54) SENSING FOR COORDINATION OF SIDELINK RESOURCES

(71) Applicant: QUALCOMM Incorporated, San Diego, CA (US)

(72) Inventors: Hui GUO, Beijing (CN); Tien Viet NGUYEN, Bridgewater, NJ (US); Sourjya DUTTA, San Diego, CA (US); Shijun WU, San Diego, CA (US); Kapil GULATI, Belle Mead, NJ (US); Gabi SARKIS, San Diego, CA (US)

(21) Appl. No.: 18/578,990

(22) PCT Filed: Sep. 11, 2021
(86) PCT No.: PCT/CN2021/117842

§ 371 Date: Jan. 12, 2024

(51) Int. Cl. H04W 72/02; H04W 72/0453; H04W 72/25; H04W 72/40

(52) U.S. Cl. CPC H04W 72/02; H04W 72/0453; H04W 72/25; H04W 72/40

(57) ABSTRACT

Various aspects of the present disclosure generally relate to wireless communication. In some aspects, a first user equipment (UE) may select, based at least in part on channel sensing, one or more subchannels for transmitting information for coordinating sidelink resources with one or more other UEs. The first UE may transmit, to at least a second UE, sidelink control information (SCI) that indicates the one or more subchannels and one or more data transmission occasions in which the information is to be transmitted. Numerous other aspects are described.

### FIELD OF THE DISCLOSURE

Aspects of the present disclosure generally relate to wireless communication and to techniques and apparatuses for sending and coordinating sidelink resources.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. “Downlink” or “forward link” refers to the communication link from the BS to the UE, and “uplink” or “reverse link” refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a first user equipment (UE). The method may include selecting, based at least in part on channel sensing, one or more subchannels for transmitting information for coordinating sidelink resources with one or more other UEs. The method may include transmitting, to at least a second UE, sidelink control information (SCI) that indicates the one or more subchannels and one or more data transmission occasions in which the information is to be transmitted.

Some aspects described herein relate to a first UE for wireless communication. The first user equipment may include a memory and one or more processors coupled to the memory. The one or more processors may be configured to select, based at least in part on channel sensing, one or more subchannels for transmitting information for coordinating sidelink resources with one or more other UEs. The one or more processors may be configured to transmit, to at least a second UE, SCI that indicates the one or more subchannels and one or more data transmission occasions in which the information is to be transmitted.

Some aspects described herein relate to a non-transitory computer-readable medium that stores a set of instructions for wireless communication by a first UE. The set of instructions, when executed by one or more processors of the UE, may cause the UE to select, based at least in part on channel sensing, one or more subchannels for transmitting information for coordinating sidelink resources with one or more other UEs. The set of instructions, when executed by one or more processors of the UE, may cause the UE to transmit, to at least a second UE, SCI that indicates the one or more subchannels and one or more data transmission occasions in which the information is to be transmitted.

Some aspects described herein relate to an apparatus for wireless communication. The apparatus may include means for selecting, based at least in part on channel sensing, one or more subchannels for transmitting information for coordinating sidelink resources with one or more other apparatuses. The apparatus may include means for transmitting, to at least another apparatus, SCI that indicates the one or more subchannels and one or more data transmission occasions in which the information is to be transmitted.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence-enabled devices). Aspects may be implemented in chip-level components, modular components, non-modular components, non-chip-level components, device-level components, or system-level components. Devices incorporating described aspects and features may include additional components and features for implementation and practice of claimed and described aspects. For example, transmission and reception of wireless signals may include a number of components for analog and digital purposes (e.g., hardware components including antennas, radio frequency chains, power amplifiers, modulators, buffers, processors, interleavers, adders, or summers). It is intended that aspects described herein may be practiced in a wide variety of devices, components, systems, distributed arrangements, or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of sidelink communications, in accordance with the present disclosure.

FIG. 4 is a diagram illustrating an example of selecting sidelink resources, in accordance with the present disclosure.

FIG. 5 is a diagram illustrating an example of using a report for sidelink resources, in accordance with the present disclosure.

FIG. 6 is a diagram illustrating an example of sensing and coordinating sidelink resources, in accordance with the present disclosure.

FIG. 7 is a diagram illustrating examples of sensing and coordinating sidelink resources, in accordance with the present disclosure.

FIG. 8 is a diagram illustrating examples of sensing and coordinating sidelink resources, in accordance with the present disclosure.

FIG. 9 is a diagram illustrating an example process performed, for example, by a first UE, in accordance with the present disclosure.

FIG. 10 is a block diagrams of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

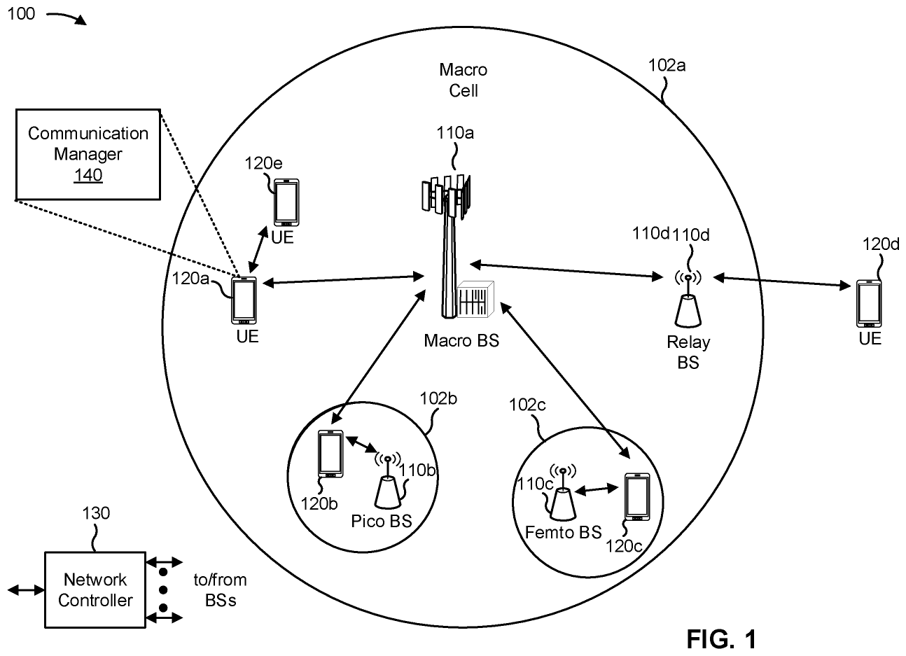

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a first UE (e.g., UE 120a) may include a communication manager 140. As described in more detail elsewhere herein, the communication manager 140 may select, based at least in part on channel sensing, one or more subchannels for transmitting information for coordinating sidelink resources with one or more other UEs. The communication manager 140 may transmit, to at least a second UE (e.g., UE 120e), sidelink control information (SCI) that indicates the one or more subchannels and one or more data transmission occasions in which the information is to be transmitted. Additionally, or alternatively, the communication manager 140 may perform one or more other operations described herein.

As indicated above, FIG. 1 is provided as an example. Other examples may differ from what is described with regard to FIG. 1.

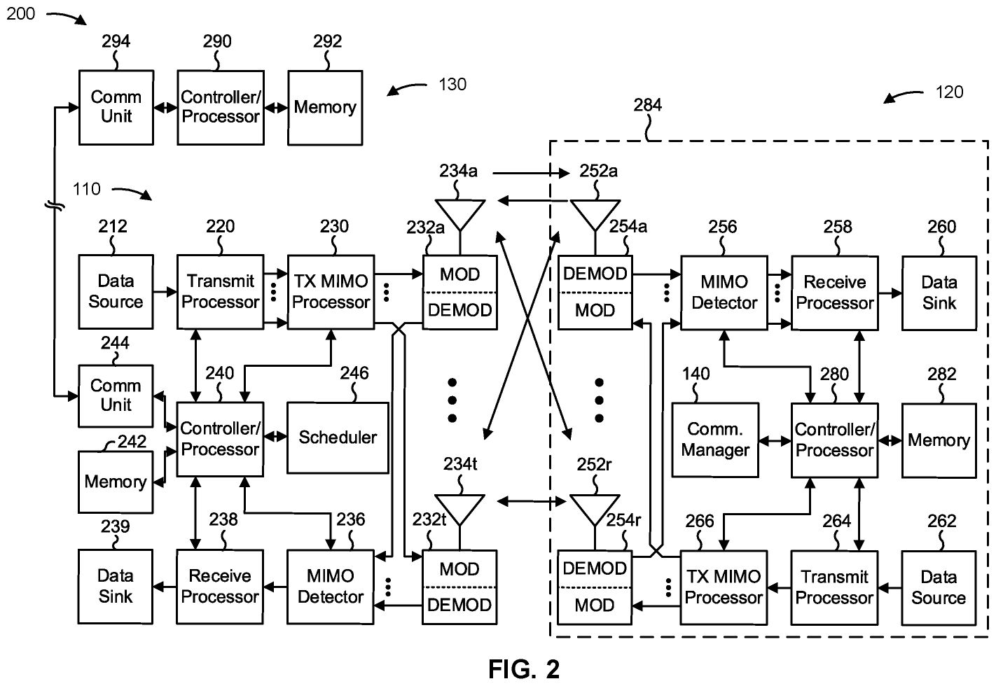

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

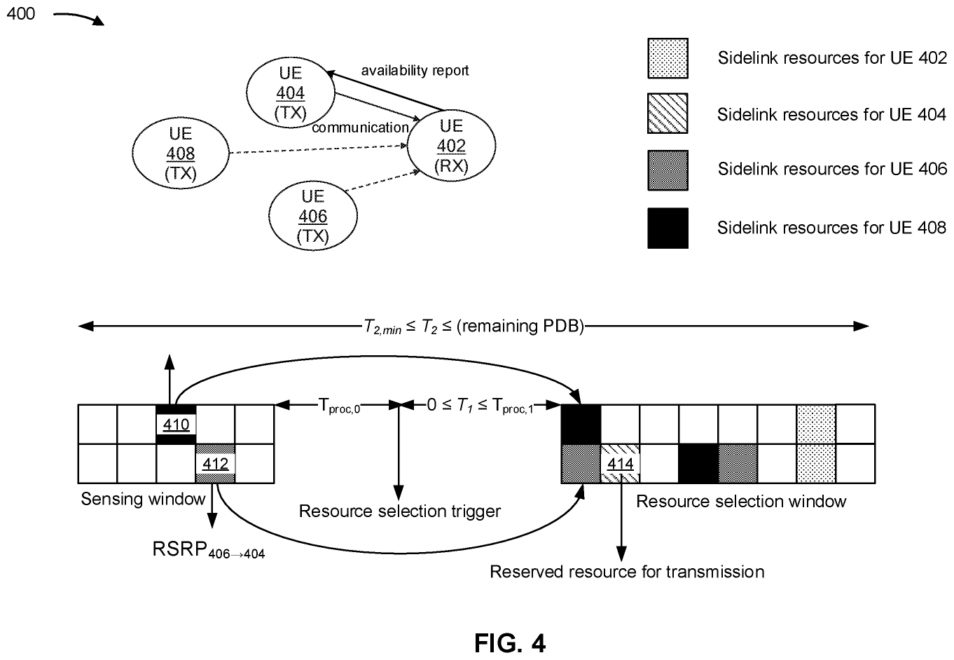

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-10).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-10).

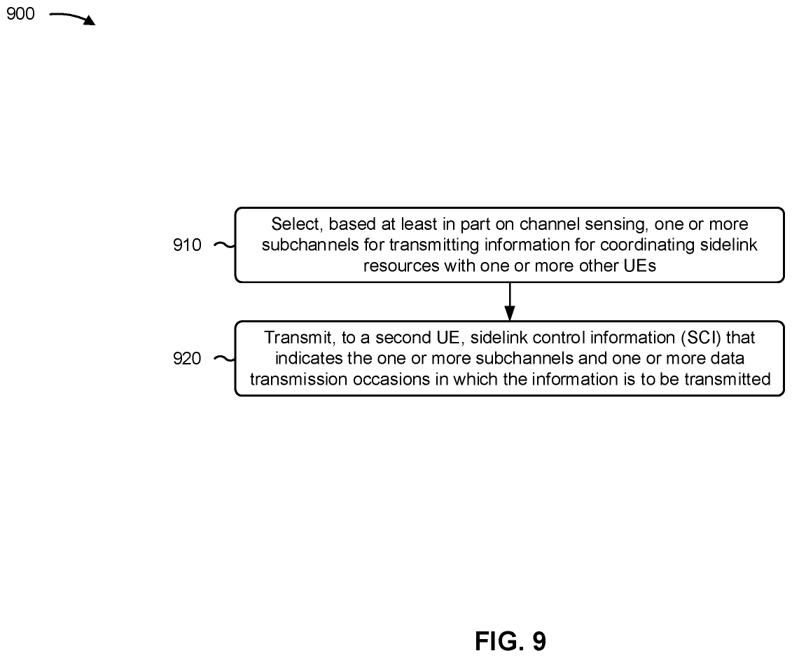

The controller/processor 240 of the base station 110, the controller/processor 280 of the UE 120, and/or any other component(s) of FIG. 2 may perform one or more techniques associated with sensing and coordinating sidelink resources, as described in more detail elsewhere herein. For example, the controller/processor 240 of the base station 110, the controller/processor 280 of the UE 120, and/or any other component(s) of FIG. 2 may perform or direct operations of, for example, process 900 of FIG. 9, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 900 of FIG. 9, and/or other processes as described herein. In some examples, executing instructions may include running the instructions, converting the instructions, compiling the instructions, and/or interpreting the instructions, among other examples.

In some aspects, a first UE (e.g., UE 120) includes means for selecting, based at least in part on channel sensing, one or more subchannels for transmitting information for coordinating sidelink resources with one or more other UEs; and/or means for transmitting, to at least a second UE, SCI that indicates the one or more subchannels and one or more data transmission occasions in which the information is to be transmitted. The means for the first UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

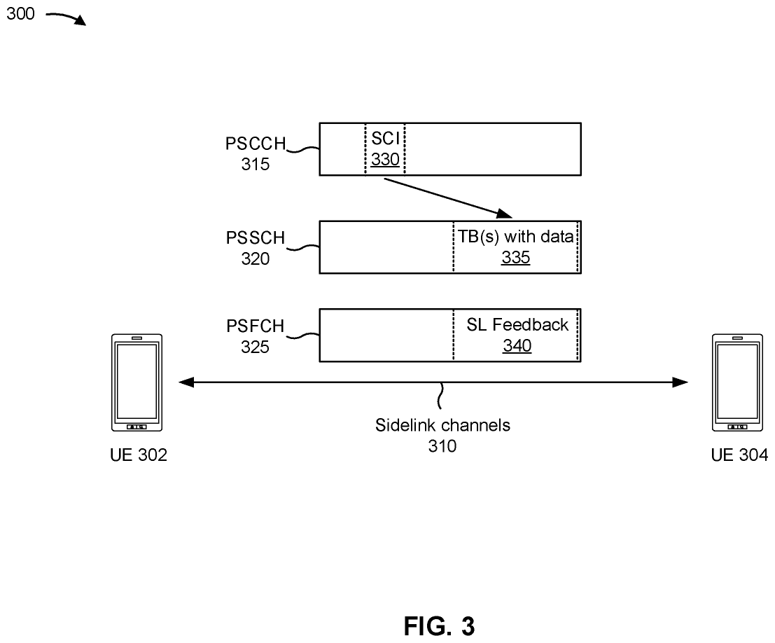

FIG. 3 is a diagram illustrating an example 300 of sidelink communications, in accordance with the present disclosure.

As shown in FIG. 3, a first UE 302 (e.g., UE 120e) may communicate with a second UE 304 (e.g., UE 120a) (and one or more other UEs) via one or more sidelink channels 310. UE 302 and UE 304 may communicate using the one or more sidelink channels 310 for P2P communications, D2D communications, V2X communications (e.g., which may include V2V communications, V2I communications, and/or V2P communications) and/or mesh networking. In some aspects, UE 302 and UE 304 may correspond to one or more other UEs. In some aspects, the one or more sidelink channels 310 may use a PC5 interface and/or may operate in a high frequency band (e.g., the 5.9 gigahertz (GHz) band). Additionally, or alternatively, UE 302 and UE 304 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a base station (e.g., base station 110) via an access link or an access channel. The PSSCH 320 may be used to communicate data, similar to a physical downlink shared channel (PDSCH) and/or a physical uplink shared channel (PUSCH) used for cellular communications with a base station via an access link or an access channel. For example, the PSCCH 315 may carry sidelink control information (SCI) 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), and/or a scheduling request (SR).

In some aspects, the one or more sidelink channels 310 may use resource pools. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, UE 304 may operate using a transmission mode where resource selection and/or scheduling is performed by UE 302 (e.g., rather than a base station). In some aspects, UE 302 and/or UE 304 may perform resource selection and/or scheduling by sensing channel availability for transmissions. For example, UE 304 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, may measure an RSRQ parameter (e.g., a PSSCH-RSRQ parameter) associated with various sidelink channels, and/or may determine a signal-to-interference ratio (SIR) associated with another UE on a sidelink channel. UE 304 may select a channel for transmission of a sidelink communication based at least in part on the measurement(s).

Additionally, or alternatively, UE 304 may perform resource selection and/or scheduling using SCI 330 received in the PSCCH 315, which may indicate occupied resources and/or channel parameters. Additionally, or alternatively, UE 304 may perform resource selection and/or scheduling by determining a channel busy rate (CBR) associated with various sidelink channels, which may be used for rate control (e.g., by indicating a maximum number of resource blocks that UE 304 can use for a particular set of subframes).

In the transmission mode where resource selection and/or scheduling is performed by UE 302, UE 302 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or a modulation and coding scheme (MCS) to be used for the upcoming sidelink transmission. In some aspects, UE 302 may generate a sidelink grant that indicates one or more parameters for semi-persistent scheduling (SPS), such as a periodicity of a sidelink transmission. Additionally, or alternatively, UE 302 may generate a sidelink grant for event-driven scheduling, such as for an on-demand sidelink message.

UE 302 and UE 304 may operate in sidelink resource allocation Mode 2, in which UE 302 and UE 304 schedule or reserve their own sidelink resources without the assistance or direction of a base station (Mode 1). In some aspects, UE 302 may indicate available sidelink resources to UE 304, and UE 304 may select a sidelink resource for transmission from these available sidelink resources. UE 304 may also sense one or more of the sidelink channels 310 to determine which sidelink resources are available. UE 304 may select a sidelink resource for transmission from the sidelink resources that UE 302 indicates as available and/or from the sidelink resources that UE 304 senses are available. As described in various aspects herein, UE 302 may schedule one or more preferred sidelink resources on behalf of UE 304.

As indicated above, FIG. 3 is provided as an example. Other examples may differ from what is described with regard to FIG. 3.

FIG. 4 is a diagram illustrating an example 400 of selecting sidelink resources, in accordance with the present disclosure. Example 400 shows a UE 402 (e.g., a UE 302) that may receive communications on a sidelink channel from other UEs (e.g., a UE 304), such as UE 404, UE 406, and/or UE 408.

As described in connection with FIGS. 4-8, UE 404 is a transmitting UE that is transmitting communications to UE 402, which is a receiving UE. UE 404 may use a report from UE 402, which may act as a reporting UE that reports available sidelink resources, preferred sidelink resources, non-preferred sidelink resources, or sidelink resource conflicts. Example 400 shows an availability report from UE 402 to UE 404 and a communication from UE 404 to UE 402.

If UE 404 is to transmit a communication to UE 402, UE 404 may sense the sidelink channel in a sensing window to determine which sidelink resources (e.g., subcarriers, subchannels) are available. A sidelink resource may be considered available if the sidelink resource was clear or had a signal energy (e.g., RSRP) that satisfied an availability threshold (e.g., measured interference or energy on the channel is lower than a maximum decibel-milliwatts (dBm) or dB, RSRP threshold). The availability threshold may be configured per transmission priority and receive priority pair. UE 404 may measure DMRSs on a PSCCH or a PSSCH, according to a configuration.

For example, UE 404 may prepare to transmit a communication to UE 402. UE 404 may have already sensed previous sidelink resources and successfully decoded SCI from UE 406 and UE 408. UE 404 may try to reserve sidelink resources, and thus may check the availability of the future sidelink resources reserved by UE 406 and UE 408 by sensing the sidelink channel in the sensing window. UE 404 may measure an RSRP of a signal from UE 408 in sidelink resource 410, and an RSRP of a signal from UE 406 in sidelink resource 412. If an observed RSRP satisfies the RSRP threshold (e.g., is lower than a maximum RSRP), the corresponding sidelink resource may be available for reservations by UE 404. UE 404 may reserve the sidelink resource (which may be a random selection from available resources). For example, UE 404 may select and reserve sidelink resource 414 for transmission. This may be in a time slot after which UE 406 and UE 408 had used sidelink resources, and UE 404 may have sensed these sidelink resources earlier.

There may be a resource selection trigger to trigger selection of sidelink resources after a processing time T_{proc,0}, and before another processing time T_{proc,1} before a resource selection window from which sidelink resources are available. The resource selection window may be a time window from which sidelink resources may be selected, and the resource selection window may extend for a remaining packet delay budget (PDB).

UE 404 may be power-sensitive and thus may not afford to continually sense all of the sidelink resources. UE 402 may be more capable of sensing and reporting on the sidelink resources because, for example, UE 402 may be a smart phone while UE 404 may be a smart watch. UE 402 may receive unicast communications from UE 404, and UE 402 may report back available resources to UE 404. UE 402 may continually sense the sidelink resources and measure interference levels involving neighboring UEs. For example, UE 402 may measure an RSRP of a signal from neighboring UE 406 as −92 dBm and an RSRP of a signal from neighboring UE 408 as −102 dBm. For a signal of a last transmission of UE 404, UE 402 measured a target signal level with an RSRP that was −90 dBm. UE 402 may estimate an SIR of a signal between UE 402 and UE 404 as −90−(−92)=2 dB and an SIR between UE 404 and UE 408 as −90−(−102)=12 dB. If the SIR of a signal from UE 404 to UE 402 with interference from UE 408 is large enough (satisfies an availability threshold) for reliable communication between UE 402 and UE 404, UE 402 may mark a sidelink resource that was reserved by UE 408 as available for use for a communication from UE 404 to UE 402. This may be useful when UE 404 has more than one data stream with varying Quality of Service (QoS) requirements or transmissions with different MCS indices.

As indicated above, FIG. 4 is provided as an example. Other examples may differ from what is described with regard to FIG. 4.

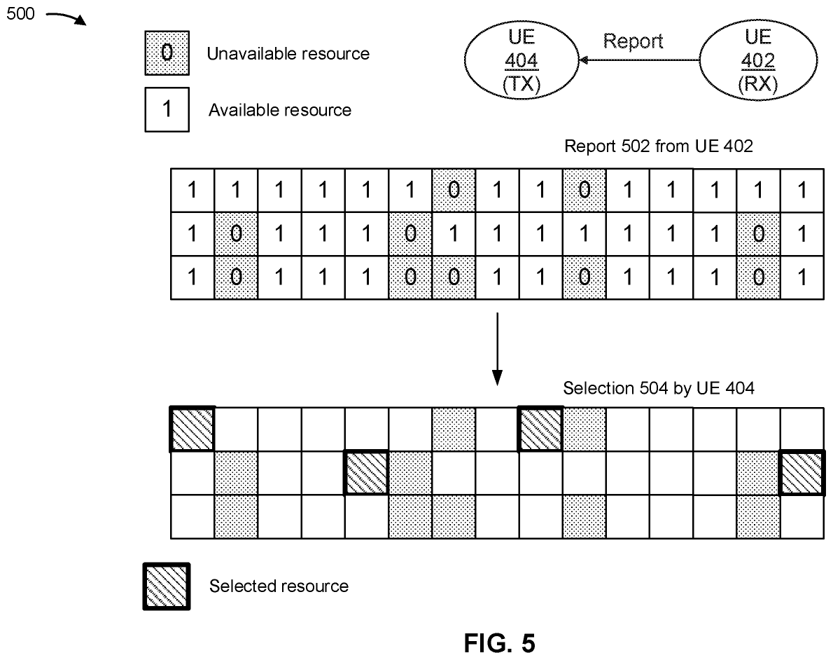

FIG. 5 is a diagram illustrating an example 500 of using a report for sidelink resources, in accordance with the present disclosure. Example 500 shows that UE 402 may transmit a report to UE 404.

UE 402 may transmit a report 502 indicating an availability of each sidelink resource. Rows in the report 502 may represent subcarriers or subchannels, and columns may represent time units (e.g., slots, symbols). The report 502 may be a binary report, such as a bitmap. For example, UE 402 may report a 1 bit for available and a 0 bit for unavailable. UE 404 may decode the report 502 and select (e.g., randomly) N resources from the available sidelink resources for potential N transmissions of a newly generated packet, or a packet of a transport block that has not been transmitted before. As shown by selection 504, UE 404 may select N=4 sidelink resources from the available sidelink resources indicated by the report 502.

In some aspects, the report 502 may involve different inter-UE coordination schemes that report different information. For example, the report 502 may include information of Type A, which indicates one or more preferred sidelink resources for transmission. The report 502 may include information of Type B, which indicates one or more non-preferred sidelink resources for transmission. The report 502 may include information of Type C, which indicates expected, potential, or detected collisions of one or more sidelink resources. Information of Type A and Type B may be for a first inter-UE coordination scheme, and information of Type C may be for a second inter-UE coordination scheme. The report 502 may involve down-selection in what resources are reported.

As indicated above, FIG. 5 is provided as an example. Other examples may differ from what is described with regard to FIG. 5.

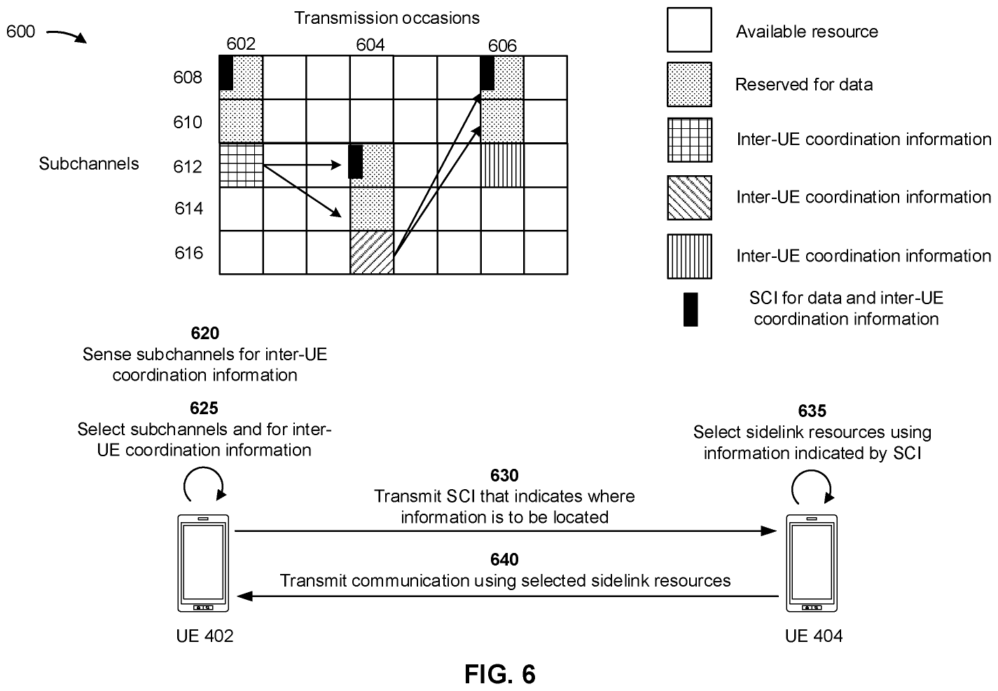

FIG. 6 is a diagram illustrating an example 600 of sensing and coordinating sidelink resources, in accordance with the present disclosure. Example 600 shows that UE 402 and UE 404 may communicate (e.g., transmit an uplink transmission and/or receive a downlink transmission) with each other. As described in connection with FIGS. 4 and 5, UE 402 is the reporting UE, and UE 404 is the transmitting UE that transmits a communication to UE 402 as the receiving UE.

UE 402 may report inter-UE coordination information to UE 404 to improve the reliability of autonomous (Mode 2) sidelink communication. While UE 402 may transmit inter-UE coordination information with data, including piggybacking the information with the data when the data is to be transmitted, UE 402 does not sense any channels for the information itself. The lack of channel sensing for the information (in addition to channel sensing for the data) may result in resource collisions that degrade communications and use additional signaling resources for retransmissions. Also, a lack of flexibility in where and when such information may be located may result in using more signaling resources than necessary.

UE 402 may transmit data in multiple data transmission occasions, shown as occasions 602, 604, and 606 in example 600. Occasion 602 may be an initial transmission of data (e.g., a transport block (TB), a packet). Occasion 604 may be a first retransmission of the data, if necessary due to a feedback message or lack of a feedback message. Occasion 606 may be a second retransmission of the data, if necessary. Occasion 604 and occasion 606 may also be repetitions of the initial transmission of data in occasion 602 (e.g., for V2X communications).

According to various aspects described herein, UE 402 may sense one or more subchannels for placement of the inter-UE coordination information and transmit SCI that indicates where the inter-UE coordination information is to be located. For example, UE 402 may sense subchannels 608, 610, 612, 614, and/or 616. UE 402 may select subchannels 612 and 614 for data transmission by UE 404 to UE 402 in the next transmission occasion 604. That is, UE 402 may reserve a quantity N subchannels for data. UE 402 may also reserve an N+1 channel (e.g., subchannel 612) in occasion 602 for the inter-UE coordination information that UE 404 is to use for transmitting data in occasion 604. The N+1 subchannel 612 may be adjacent to one of the N subchannels (e.g., subchannel 610) reserved for the transmission of data. Other subchannels may be reserved in occasion 604 and occasion 606. In some aspects, UE 402 may transmit SCI in a first part of a first subchannel (e.g., subchannel 608) to indicate which subchannels UE 404 should use (or not use) for data transmission and/or in which subchannel the inter-UE coordination information is located. Note that inter-UE coordination messages may not be retransmitted and thus UE 402 may transmit new inter-UE coordination information in each transmission occasion. This is shown in example 600 with different shading for the information in each transmission occasion. Also note that resource reservations for data may be reselected or pre-empted. For example, a piggybacked subchannel for inter-UE coordination information may be reselected or dropped.

Example 600 shows an example of sensing and coordinating sidelink resources. As shown by reference number 620, UE 402 may sense a sidelink channel in a sensing window for UE 404 (e.g., using antenna 252, demodulator 254, MIMO detector 256, receive processor 258, controller/processor 280, and/or memory 282). UE 402 may sense the sidelink channel based at least in part on past sidelink resources used by UE 404 or other UEs and/or future reserved sidelink resources for UE 404 or other UEs. UE 402 may select a quantity N subchannels (one or more) in which UE 404 is to transmit data to one or more other UEs. As shown by reference number 625, UE 402 may also select one or more subchannels that UE 404 may use (or not use) as the N+1 subchannel in each transmission occasion for transmitting inter-UE coordination information to one or more other UEs (e.g., using controller/processor 280 and/or memory 282). The N+1 subchannel for the information may be adjacent to an upper or lower subchannel of the N subchannels for data. This information may include the report 502, for example.

As shown by reference number 630, UE 402 may transmit an indication of where the inter-UE coordination information is to be located (e.g., using antenna 252, transmit processor 264, TX MIMO processor 266, modulator 254, controller/processor 280, and/or memory 282). UE 402 may transmit the indication in SCI. The SCI may indicate reservations for both the data and the information. The SCI may include one or more bits that indicate that the SCI also locates the information.

As shown by reference number 635, UE 404 may select sidelink resources using the inter-UE coordination information from UE 402 (e.g., using controller/processor 280 and/or memory 282). UE 404 may (optionally) sense the sidelink channel for scheduled sidelink resources indicated by UE 402, other candidate sidelink resources indicated by UE 402, reserved sidelink resources indicated by other UEs, and/or any available sidelink resources indicated by other UEs.

As shown by reference number 640, UE 404 may transmit a communication to UE 402 on a selected sidelink resource (e.g., using antenna 252, transmit processor 264, TX MIMO processor 266, modulator 254, controller/processor 280, and/or memory 282). UE 404 may transmit other communications to UE 402 with other selected sidelink resources.

By channel sensing for a subchannel for inter-UE coordination information and by using SCI to indicate a location of the subchannel, UE 402 and UE 404 may improve inter-UE coordination information with improved flexibility that conserves signaling resources and reduces latency caused by sidelink resource collisions.

As indicated above, FIG. 6 is provided as an example. Other examples may differ from what is described with regard to FIG. 6.

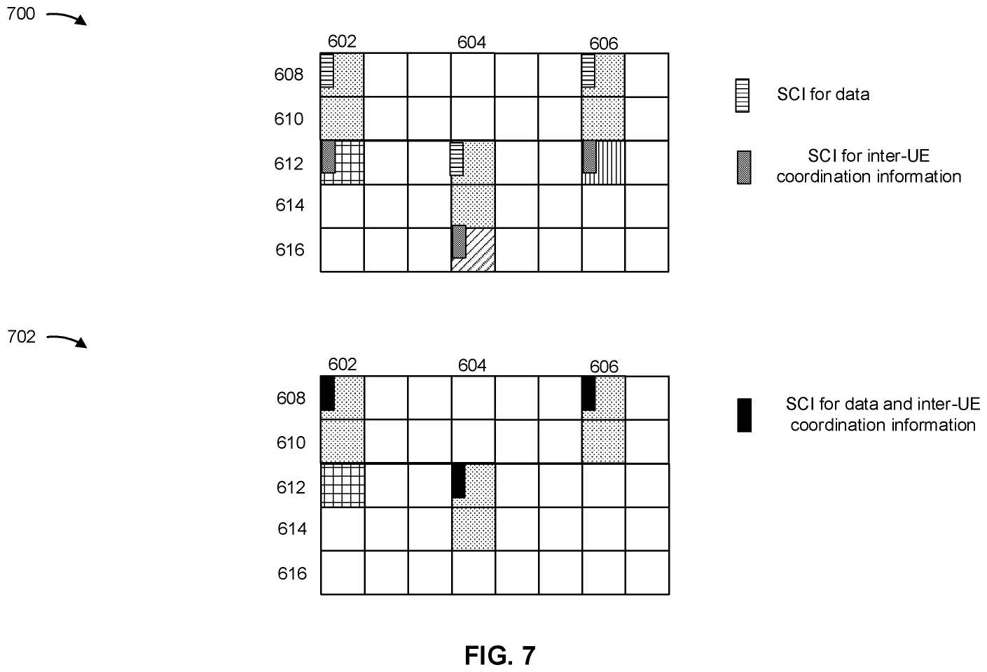

FIG. 7 is a diagram illustrating examples 700 and 702 of resources for sensing and coordinating sidelink resources, in accordance with the present disclosure.

In some aspects, rather than using a single SCI for indicating reservations for the data and the inter-UE coordination information, UE 402 may transmit a first SCI that indicates N subchannels that are reserved for data and a second SCI that indicates an N+1 subchannel that is reserved for the information. The second SCI may be of an SCI type that is dedicated to inter-UE coordination information. The second SCI may include one or more bits that indicate that the second SCI is of the SCI type.

As shown by example 700, UE 402 may transmit the first SCI in the first subchannel reserved for data (e.g., subchannel 608). UE 402 may transmit the second SCI in the subchannel reserved for the inter-UE coordination information (e.g., subchannel 612). In some aspects, the first SCI or the second SCI may indicate a priority for the information. In this way, other UEs may overtake the N+1 subchannel reserved for the information if the information has a lower priority than the data.

In some aspects, UE 402 may down-select the transmission occasions in which the inter-UE coordination information is transmitted. As shown by example 702, UE 402 may reserve the N+1 subchannel for the information in only the first, initial transmission occasion 602. UE 402 does not include the information in an adjacent subchannel for occasion 604 or occasion 606, which may be retransmission occasions for the transport block or packet. UE 402 may not need to sense for the N+1 channel in every transmission occasion for the transport block or packet (or for a resource selection window). This may cause UE 402 and UE 404 to conserve processing resources and signaling resources.

In some aspects, when UE 402 selects resources in a resource selection window, for every new data packet with an initial transmission (re)selection that is triggered, UE 402 may take into account the N+1 subchannel with the first transmission occasion when calculating an available resource ratio.

As indicated above, FIG. 7 provides some examples. Other examples may differ from what is described with regard to FIG. 7.

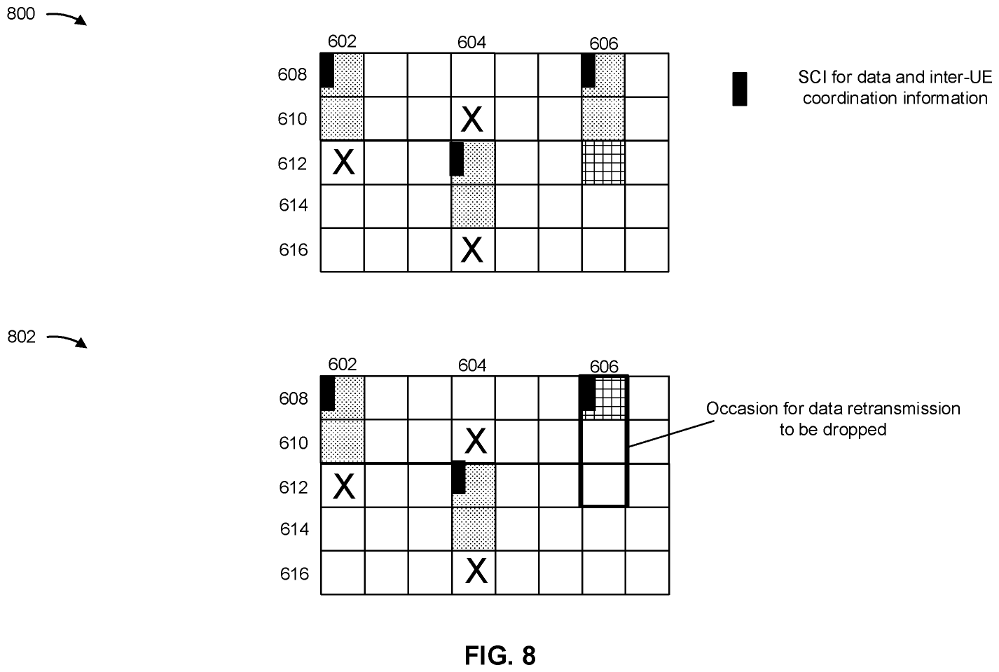

FIG. 8 is a diagram illustrating examples 800 and 802 of resources for sensing and coordinating sidelink resources, in accordance with the present disclosure.

In some scenarios, as shown by example 800, an N+1 subchannel for inter-UE coordination information may not be available adjacent to any N subchannels for data in occasion 602 or occasion 604. Unavailability is shown by an “X”. UE 402 may sense that subchannel 612 may be available for occasion 606.

A data packet may be transmitted up to a maximum quantity of times until the data packet is correctly decoded by all receivers. However, if the data retransmission at occasion 604 is successful (acknowledgement (ACK) received or no negative acknowledgment (NACK) received), there will be no transmission of data at occasion 606 on which the inter-UE coordination information could piggyback. Occasion 606 is to be dropped. In some aspects, UE 402 may use a reserved but yet unused sidelink resource for data. For example, UE 402 may indicate in SCI of occasion 606 that the information is to be included in one of the N subchannels of occasion 606 reserved for data (e.g., subchannel 608 or subchannel 610). In example 802, UE 402 may use subchannel 608 for the information if subchannel 612 remains unavailable. By using unused data resources for inter-UE coordination information, UE 402 and UE 404 may still coordinate sidelink resource reservations.

As indicated above, FIG. 8 provides some examples. Other examples may differ from what is described with regard to FIG. 8.

FIG. 9 is a diagram illustrating an example process 900 performed, for example, by a first UE, in accordance with the present disclosure. Example process 900 is an example where the first UE (e.g., UE 120) performs operations associated with sensing and coordinating sidelink resources.

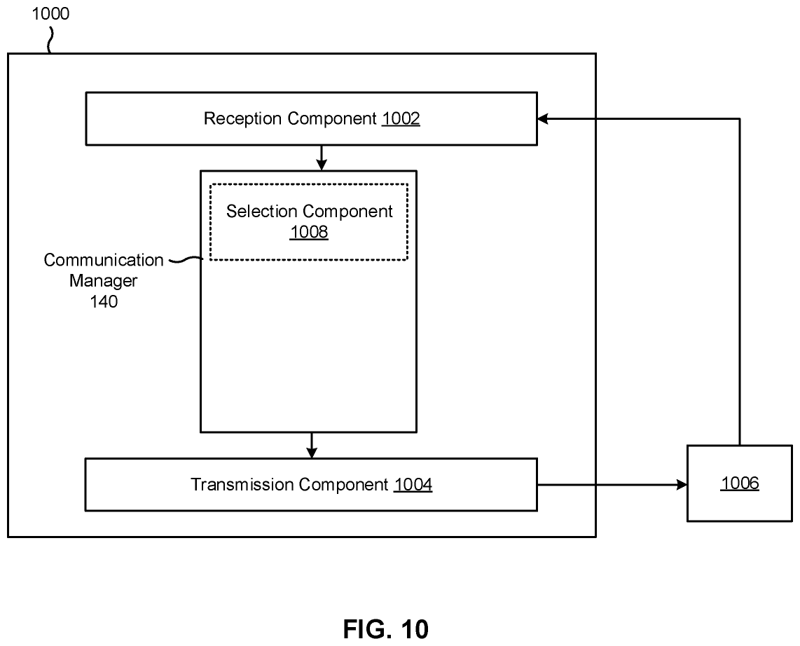

As shown in FIG. 9, in some aspects, process 900 may include selecting, based at least in part on channel sensing, one or more subchannels for transmitting information for coordinating sidelink resources with one or more other UEs (block 910). For example, the UE (e.g., using communication manager 140 and/or selection component 1008 depicted in FIG. 10) may select, based at least in part on channel sensing, one or more subchannels for transmitting information for coordinating sidelink resources with one or more other UEs, as described above.

As further shown in FIG. 9, in some aspects, process 900 may include transmitting, to at least a second UE, SCI that indicates the one or more subchannels and one or more data transmission occasions in which the information is to be transmitted (block 920). For example, the UE (e.g., using communication manager 140 and/or transmission component 1004 depicted in FIG. 10) may transmit, to at least a second UE, SCI that indicates the one or more subchannels and one or more data transmission occasions in which the information is to be transmitted, as described above.

Process 900 may include additional aspects, such as any single aspect or any combination of aspects described below and/or in connection with one or more other processes described elsewhere herein.

In a first aspect, the SCI indicates that the information is to be included in multiple data transmission occasions.

In a second aspect, alone or in combination with the first aspect, transmitting the SCI includes transmitting the SCI in a subchannel that is to include data.

In a third aspect, alone or in combination with one or more of the first and second aspects, transmitting the SCI includes transmitting the SCI in the one or more subchannels for transmitting the information.

In a fourth aspect, alone or in combination with one or more of the first through third aspects, the SCI is of an SCI type that is dedicated to transmitting information for coordinating sidelink resources with one or more UEs.

In a fifth aspect, alone or in combination with one or more of the first through fourth aspects, the SCI includes at least one bit to indicate that the SCI type is dedicated to transmitting information for coordinating sidelink resources with one or more UEs.

In a sixth aspect, alone or in combination with one or more of the first through fifth aspects, the SCI further indicates one or more subchannels and at least one of the one or more data transmission occasions in which data is to be transmitted.

In a seventh aspect, alone or in combination with one or more of the first through sixth aspects, the SCI includes at least one bit to indicate that the SCI indicates the one or more subchannels and the one or more data transmission occasions in which the information is to be transmitted, and indicates one or more subchannels and at least one of the one or more data transmission occasions in which data is to be transmitted.

In an eighth aspect, alone or in combination with one or more of the first through seventh aspects, process 900 includes transmitting a separate SCI that indicates one or more subchannels and at least one of the one or more data transmission occasions in which data is to be transmitted.

In a ninth aspect, alone or in combination with one or more of the first through eighth aspects, the SCI indicates that the information is to be included in an initial data transmission occasion of the one or more data transmission occasions and not in retransmission occasions of the one or more data transmission occasions.

In a tenth aspect, alone or in combination with one or more of the first through ninth aspects, each subchannel of the one or more subchannels in which the information is to be included is adjacent to a subchannel that is to include data.

In an eleventh aspect, alone or in combination with one or more of the first through tenth aspects, the channel sensing includes sensing whether a subchannel, which is adjacent to a subchannel that is to include data, is available for the information.

In a twelfth aspect, alone or in combination with one or more of the first through eleventh aspects, the SCI indicates that the information is to be included in a subchannel that is reserved for data in a data transmission occasion that is to be dropped for data transmission based at least in part on a feedback message.

In a thirteenth aspect, alone or in combination with one or more of the first through twelfth aspects, transmitting the SCI includes transmitting the SCI in the subchannel that is reserved for data in the data transmission occasion that is to be dropped for data transmission.

In a fourteenth aspect, alone or in combination with one or more of the first through thirteenth aspects, the SCI indicates that the information is to be included in no more than one data transmission occasion.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication. The apparatus 1000 may be a first UE, or a first UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 140. The communication manager 140 may include a selection component 1008, among other examples.

In some aspects, the apparatus 1000 may be configured to perform one or more operations described herein in connection with FIGS. 1-8. Additionally, or alternatively, the apparatus 1000 may be configured to perform one or more processes described herein, such as process 900 of FIG. 9. In some aspects, the apparatus 1000 and/or one or more components shown in FIG. 10 may include one or more components of the first UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the first UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the first UE described in connection with FIG. 2. In some aspects, the transmission component 1004 may be co-located with the reception component 1002 in a transceiver.

The selection component 1008 may select, based at least in part on channel sensing, one or more subchannels for transmitting information for coordinating sidelink resources with one or more other UEs. The transmission component 1004 may transmit, to a second UE, SCI that indicates the one or more subchannels and one or more data transmission occasions in which the information is to be transmitted.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:
Aspect 1: A method of wireless communication performed by a first user equipment (UE), comprising: selecting, based at least in part on channel sensing, one or more subchannels for transmitting information for coordinating sidelink resources with one or more other UEs; and transmitting, to at least a second UE, sidelink control information (SCI) that indicates the one or more subchannels and one or more data transmission occasions in which the information is to be transmitted.
Aspect 2: The method of Aspect 1, wherein the SCI indicates that the information is to be included in multiple data transmission occasions.
Aspect 3: The method of Aspect 1 or 2, wherein transmitting the SCI includes transmitting the SCI in a subchannel that is to include data.
Aspect 4: The method of Aspect 1 or 2, wherein transmitting the SCI includes transmitting the SCI in the one or more subchannels for transmitting the information.
Aspect 5: The method of any of Aspects 1-4, wherein the SCI is of an SCI type that is dedicated to transmitting information for coordinating sidelink resources with one or more UEs.
Aspect 6: The method of Aspect 5, wherein the SCI includes at least one bit to indicate that the SCI type is dedicated to transmitting information for coordinating sidelink resources with one or more UEs.
Aspect 7: The method of any of Aspects 1-6, wherein the SCI further indicates one or more subchannels and at least one of the one or more data transmission occasions in which data is to be transmitted.
Aspect 8: The method of any of Aspects 1-7, wherein the SCI includes at least one bit to indicate that the SCI indicates the one or more subchannels and the one or more data transmission occasions in which the information is to be transmitted and indicates one or more subchannels and at least one of the one or more data transmission occasions in which data is to be transmitted.
Aspect 9: The method of any of Aspects 1-6, further comprising transmitting a separate SCI that indicates one or more subchannels and at least one of the one or more data transmission occasions in which data is to be transmitted.
Aspect 10: The method of any of Aspects 1-9, wherein the SCI indicates that the information is to be included in an initial data transmission occasion of the one or more data transmission occasions and not in retransmission occasions of the one or more data transmission occasions.
Aspect 11: The method of any of Aspects 1-10, wherein each subchannel of the one or more subchannels in which the information is to be included is adjacent to a subchannel that is to include data.
Aspect 12: The method of Aspect 11, wherein the channel sensing includes sensing whether a subchannel, which is adjacent to a subchannel that is to include data, is available for the information.
Aspect 13: The method of any of Aspects 1-9 and 11-12, wherein the SCI indicates that the information is to be included in a subchannel that is reserved for data in a data transmission occasion that is to be dropped for data transmission based at least in part on a feedback message.
Aspect 14: The method of Aspect 13, wherein transmitting the SCI includes transmitting the SCI in the subchannel that is reserved for data in the data transmission occasion that is to be dropped for data transmission.
Aspect 15: The method of any of Aspects 1-9 and 11-12, wherein the SCI indicates that the information is to be included in no more than one data transmission occasion.
Aspect 16: An apparatus for wireless communication at a device, comprising a processor; memory coupled with the processor; and instructions stored in the memory and executable by the processor to cause the apparatus to perform the method of one or more of Aspects 1-15.
Aspect 17: A device for wireless communication, comprising a memory and one or more processors coupled to the memory, the one or more processors configured to perform the method of one or more of Aspects 1-15.
Aspect 18: An apparatus for wireless communication, comprising at least one means for performing the method of one or more of Aspects 1-15.
Aspect 19: A non-transitory computer-readable medium storing code for wireless communication, the code comprising instructions executable by a processor to perform the method of one or more of Aspects 1-15.
Aspect 20: A non-transitory computer-readable medium storing a set of instructions for wireless communication, the set of instructions comprising one or more instructions that, when executed by one or more processors of a device, cause the device to perform the method of one or more of Aspects 1-15.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a first user equipment (UE), comprising:
selecting, based at least in part on channel sensing, one or more subchannels for transmitting information for coordinating sidelink resources with one or more other UEs; and
transmitting, to at least a second UE, sidelink control information (SCI) that indicates the one or more subchannels and one or more data transmission occasions in which the information is to be transmitted.

2. The method of claim 1, wherein the SCI indicates that the information is to be included in multiple data transmission occasions.

3. The method of claim 1, wherein transmitting the SCI includes transmitting the SCI in a subchannel that is to include data.

4. The method of claim 1, wherein transmitting the SCI includes transmitting the SCI in the one or more subchannels for transmitting the information.

5. The method of claim 1, wherein the SCI is of an SCI type that is dedicated to transmitting information for coordinating sidelink resources with one or more UEs.

6. The method of claim 5, wherein the SCI includes at least one bit to indicate that the SCI type is dedicated to transmitting information for coordinating sidelink resources with one or more UEs.

7. The method of claim 1, wherein the SCI further indicates one or more subchannels and at least one of the one or more data transmission occasions in which data is to be transmitted.

8. The method of claim 1, wherein the SCI includes at least one bit to indicate that the SCI indicates the one or more subchannels and the one or more data transmission occasions in which the information is to be transmitted and indicates one or more subchannels and at least one of the one or more data transmission occasions in which data is to be transmitted.

9. The method of claim 1, further comprising transmitting a separate SCI that indicates one or more subchannels and at least one of the one or more data transmission occasions in which data is to be transmitted.

10. The method of claim 1, wherein the SCI indicates that the information is to be included in an initial data transmission occasion of the one or more data transmission occasions and not in retransmission occasions of the one or more data transmission occasions.

11. The method of claim 1, wherein each subchannel of the one or more subchannels in which the information is to be included is adjacent to a subchannel that is to include data.

12. The method of claim 11, wherein the channel sensing includes sensing whether a subchannel, which is adjacent to a subchannel that is to include data, is available for the information.

13. The method of claim 1, wherein the SCI indicates that the information is to be included in a subchannel that is reserved for data in a data transmission occasion that is to be dropped for data transmission based at least in part on a feedback message.

14. The method of claim 13, wherein transmitting the SCI includes transmitting the SCI in the subchannel that is reserved for data in the data transmission occasion that is to be dropped for data transmission.

15. The method of claim 1, wherein the SCI indicates that the information is to be included in no more than one data transmission occasion.

16. A first user equipment (UE) for wireless communication, comprising:
a memory; and
one or more processors, coupled to the memory, configured to:
select, based at least in part on channel sensing, one or more subchannels for transmitting information for coordinating sidelink resources with one or more other UEs; and
transmit, to at least a second UE, sidelink control information (SCI) that indicates the one or more subchannels and one or more data transmission occasions in which the information is to be transmitted.

17. The first UE of claim 16, wherein the SCI indicates that the information is to be included in multiple data transmission occasions.

18. The first UE of claim 16, wherein the one or more processors, to transmit the SCI, are configured to transmit the SCI in a subchannel that is to include data.

19. The first UE of claim 16, wherein the one or more processors, to transmit the SCI, are configured to transmit the SCI in the one or more subchannels for transmitting the information.

20. The first UE of claim 16, wherein the SCI is of an SCI type that is dedicated to transmitting information for coordinating sidelink resources with one or more UEs.

21. The first UE of claim 20, wherein the SCI includes at least one bit to indicate that the SCI type is dedicated to transmitting information for coordinating sidelink resources with one or more UEs.

22. The first UE of claim 16, wherein the SCI further indicates one or more subchannels and at least one of the one or more data transmission occasions in which data is to be transmitted.

23. The first UE of claim 16, wherein the SCI includes at least one bit to indicate that the SCI indicates the one or more subchannels and the one or more data transmission occasions in which the information is to be transmitted and indicates one or more subchannels and at least one of the one or more data transmission occasions in which data is to be transmitted.

24. The first UE of claim 16, wherein the one or more processors are configured to transmit a separate SCI that indicates one or more subchannels and at least one of the one or more data transmission occasions in which data is to be transmitted.

25. The first UE of claim 16, wherein the SCI indicates that the information is to be included in an initial data transmission occasion of the one or more data transmission occasions and not in retransmission occasions of the one or more data transmission occasions.

26. The first UE of claim 16, wherein each subchannel of the one or more subchannels in which the information is to be included is adjacent to a subchannel that is to include data.

27. The first UE of claim 26, wherein the channel sensing includes sensing whether a subchannel, which is adjacent to a subchannel that is to include data, is available for the information.

28. The first UE of claim 16, wherein the SCI indicates that the information is to be included in a subchannel that is reserved for data in a data transmission occasion that is to be dropped for data transmission based at least in part on a feedback message.

29. The first UE of claim 28, wherein the one or more processors, to transmit the SCI, are configured to transmit the SCI in the subchannel that is reserved for data in the data transmission occasion that is to be dropped for data transmission.

30. The first UE of claim 16, wherein the SCI indicates that the information is to be included in no more than one data transmission occasion.
